(19) United States
(12) Patent Application Publication
(10) Pub. No.: US 2026/0158393 A1
(43) Pub. Date: Jun. 11, 2026

(54) GAME MAKER MODEL FOR GENERATING GAME APPLICATIONS

(71) Applicant: Lemon Inc., Grand Cayman (KY)

(72) Inventors: Blake Garrett Fuselier, Los Angeles, CA (US); Runze Zhang, Los Angeles, CA (US); Felicity Wing Tin Yick, Los Angeles, CA (US); Jie Meng, Los Angeles, CA (US); Jagminder Singh Shergill, Los Angeles, CA (US); Runjia Tian, Los Angeles, CA (US); Xiaoran Ni, Los Angeles, CA (US)

(21) Appl. No.: 18/977,665

(22) Filed: Dec. 11, 2024

(51) Int. Cl. A63F 13/63; G06F 40/40; G06T 11/00; G06T 11/20; G06T 11/60

(52) U.S. Cl. CPC A63F 13/63; G06F 40/40; G06T 11/10; G06T 11/23; G06T 11/60; G06T 2200/24

(57) ABSTRACT

A computing system receives an input prompt, and generates a plurality of game asset prompts and a background image prompt based on the user input. The plurality of game asset prompts and the background image prompt include a common style description. The system then inputs the plurality of game asset prompts and the background image prompt into a diffusion model to generate a plurality of game asset images and a background image, respectively, and generates the game application using the plurality of game asset images and the background image.

### BACKGROUND

In recent years, advancements in machine learning and natural language processing (NLP) have opened new possibilities for automating creative and technical tasks, including the development of game applications. The promise of automated game design is particularly compelling in game development. However, despite significant progress, there remain challenges when generating game content that is visually cohesive across various game elements such as characters, backgrounds, and environments.

One of the primary challenges in generating visually cohesive games lies in achieving stylistic and thematic consistency. When creating a game application, a cohesive visual appearance of the different game elements is important for delivering an immersive user experience. Consistency in visual style, drawing techniques, and theme throughout the game's assets can ensure that the game looks polished and aesthetically pleasing. Any inconsistencies can look jarring and disconcerting during game play. For example, characters that appear to have a vastly different artistic style or color scheme than their environment can detract from the overall user experience, breaking the player's immersion. Variations in texture, shading, perspective, and color tone can prevent the entire game as a whole from achieving a unified look and feel. Conventional processes have yet to fully harness the capabilities of language models to design and build game applications with stylistic and thematic consistency.

### SUMMARY

In view of the above issues, a computing system is provided for generating a game application. The computing system includes processing circuitry and memory storing instructions that, when executed, cause the processing circuitry to receive a user input, generate a plurality of game asset prompts and a background image prompt based on the user input, the plurality of game asset prompts and the background image prompt including a common style description, input the plurality of game asset prompts and the background image prompt into a diffusion model to generate a plurality of game asset images and a background image, respectively, and generate the game application using the plurality of game asset images and the background image.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 illustrates a schematic view of a computing system according to an example of the present disclosure.

FIG. 2 illustrates a schematic view of the operations of the trained machine learning game maker model of the computing system of FIG. 1.

FIG. 3 illustrates a detailed schematic of an example of the inputs and outputs of the image generating diffusion model of FIGS. 1 and 2.

FIG. 4 illustrates an example of a user input that may be processed by the trained machine learning game maker model of FIGS. 1 and 2 to generate a natural language response and a game application.

FIG. 5 illustrates an example of a screenshot of the game application generated in the example of FIGS. 3 and 4.

FIG. 6 is a flow chart of a method for generating a game application according to an example embodiment of the present disclosure.

FIG. 7 shows an example computing environment of the present disclosure in which the computing system of FIG. 1 may be enacted.

### DETAILED DESCRIPTION

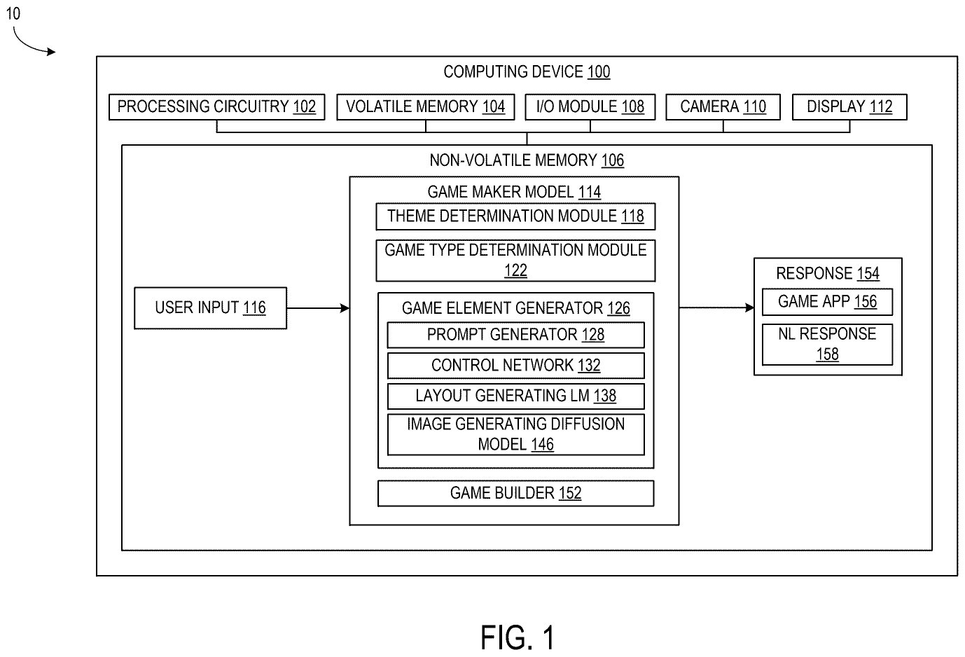

FIG. 1 shows a schematic view of a first example computing system 10 including a computing device 100 for generation of a game application 156 using a trained machine learning game maker model 114. The computing device 100 includes processing circuitry 102 (e.g., central processing units, or “CPUs”), volatile memory 104, non-volatile memory 106, an input/output (I/O) module 108, a camera 110, and a display 112. The different components are operatively coupled to one another. The non-volatile memory 106 stores instructions to execute the trained machine learning game maker model 114 which is configured to receive a user input 116 and generate a response 154 including the game application 156 and a natural language response 158 based on the user input 116.

The trained machine learning game maker model 114 includes a theme determination module 118 configured to determine a theme based on the user input 116, and a game type determination module 122 configured to determine a game type based on the user input 116. The game maker model 114 further includes a game element generator 126 configured to generate a plurality of game asset prompts and a background image prompt based on the user input 116, the game type, and the theme, the plurality of game asset prompts and the background image prompt including a common style description. The game element generator 126 inputs the plurality of game asset prompts and the background image prompt into a diffusion model 146 to generate a plurality of game asset images and a background image, respectively. The game maker model 114 also includes a game builder 152 configured to generate the game application 156 using the plurality of game asset images and the background image generated by the game element generator 126, which includes a prompt generator 128, a control network 132, a layout generating language model 138, and the image generating diffusion model 146.

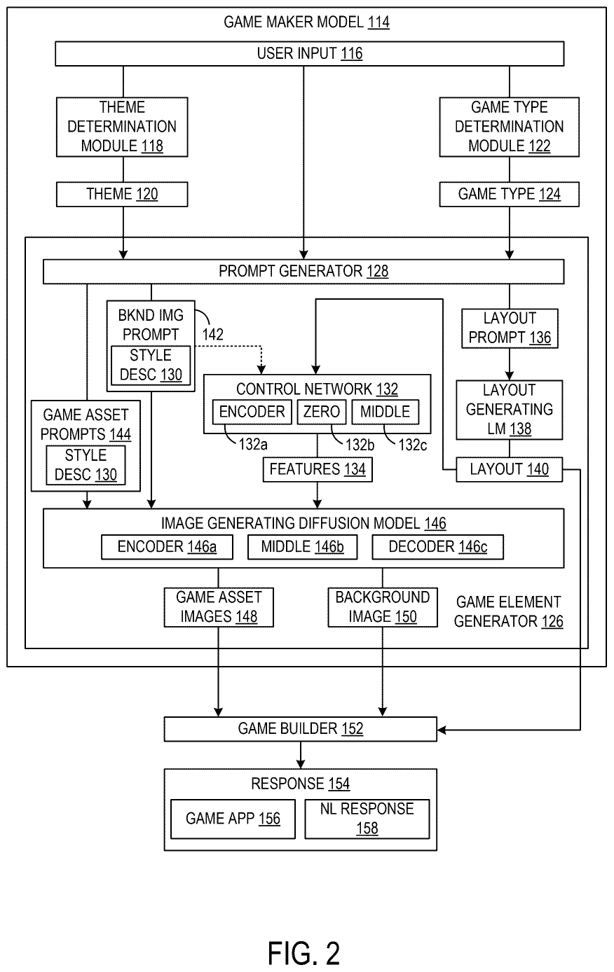

Referring to FIG. 2, the operations of the game maker model 114 are described in further detail. The game maker model 114 receives user input 116, which may mention various aspects of the desired game, such as game type, themes, player objectives, character dynamics, or overall game mechanics. Responsive to receiving the user input 116, the theme determination module 118 analyzes the user input 116 to determine a corresponding theme 120, and the game type determination module 122 analyzes the user input 116 to determine a corresponding game type 124. The theme determination module 118 and the game type determination module 122 may be configured as language models, for example.

A variety of themes 120 may be identified by the theme determination module 118. For example, a space theme may feature astronauts as characters and moon rocks or stalagmites as platforms. A fantasy theme may feature dragons as characters, enchanted forests as environments, and magical artifacts as interactive elements. A mystery theme may involve detectives as characters, hidden clues to be discovered, and puzzles that require solving to progress. An underwater theme may feature aquatic creatures as characters, coral reefs as platforms, and ocean currents influencing character movement. A post-apocalyptic theme may present survivors as characters, ruined cities as levels, and scarce resources to manage. Other themes may include sports, such as soccer or basketball games, or science fiction featuring futuristic weapons and alien species.

The game types 124 generated by the system may include a variety of genres and objectives. For example, a platformer game involves navigating a character through a game environment by jumping, climbing, or moving between platforms of varying heights. A survival game focuses on the player's ability to stay alive for as long as possible by overcoming threats, managing resources, and adapting to changing environments. Another game type is the A-to-B game, where the player's goal is to move a character from point A to point B, often navigating obstacles, solving puzzles, or avoiding enemies along the way.

The identified theme 120, the identified game type 124, and the original user input 116 are fed into the game element generator 126, which generates game asset images 148 and a background image 150 based on the identified theme 120, the identified game type 124 and the original user input 116. A prompt generator 128 receives the identified theme 120, the identified game type 124 and the original user input 116 to generate game asset prompts 144 and a background image prompt 142 that share a common style description 130.

The game asset images 148 are understood to refer to graphical representations utilized within digital or virtual gaming environments that visually depict various game assets. Game assets encompass a diverse range of elements that contribute to the gaming experience. These include, but are not limited to, main entities, such as the protagonist characters controlled by players, and secondary entities, which may represent enemy characters or non-player characters (NPCs).

Furthermore, game assets may also encompass environmental assets which include terrain features, ground surfaces, and natural or man-made obstacles, such as rocks, trees, water bodies, or architectural structures. Additionally, game assets may also include static objects, often fixed in position and serving decorative, thematic, or functional purposes, such as furniture, streetlamps, or unmovable props. Further, game assets may also encompass interactive objects, which respond to player input or actions, such as doors that open upon interaction, switches, and levers, as well as collectibles like coins, keys, or power-ups.

The prompt generator 128 also generates a layout prompt 136 to generate a layout 140 for the background image 150. For example, the layout prompt 136 may request a layout 140 defining the x, y coordinates of each structural element, such as a platform or a pillar in the game. The layout generating language model 138 generates a layout 140 based on the layout prompt 136. The layout 140 may be a bare-bones image representation composed of basic geometric shapes, such as rectangles representing the pillars.

The layout 140 is fed into the control network 132 to generate features 134 that are subsequently inputted into a pre-trained diffusion model 146 that generates the background image 150 from latent noise through iterative denoising steps, in which the noise is processed through a series of convolutional layers and attention mechanisms to progressively refine the background image 150. The diffusion model 146 may have a latent diffusion model architecture and the control network 132 may be a neural network that takes the layout 140 as input to provide conditioning and steer generation of the background image 150 by the diffusion model 146. In one specific example, the diffusion model 146 may be the Stable Diffusion model and the control network 132 may be the ControlNet for the Stable Diffusion model.

The diffusion model 146 includes an encoder 146a comprising a first set of blocks, a middle block 146b comprising a second set of blocks, and a decoder 146c comprising a third set of blocks. The encoder 146a downsamples the latent noise, and the decoder 146c upsamples the latent representations back to the original resolution to generate the game asset images 148 and the background image 150. The diffusion model 146 uses U-Net architecture, which processes the noise in a denoising process through a series of ResNet blocks and attention layers in the encoder 146a, the middle block 146b, and the decoder 146c, progressively refining the image to generate the game asset images 148 and the background image 150. The background image prompt 142 and the game asset prompts 144 are inputted into the attention layers of the encoder 146a, the middle block 146b, and/or the decoder 146c of the diffusion model 146 as the denoising process progresses so that the final game asset images 148 and the background image 150 reflect the features of game asset prompts 144 and the background image prompt 142, respectively, and thus rendered in the same style described in the common style description 130.

The seed value of the diffusion model 146 may be set the same each time a prompt 136, 142, 144 is inputted into the diffusion model 146 to generate an image. In other words, the seed value of the diffusion model 146 when the game asset prompt 144 is inputted into the diffusion model 146 to generate a game asset image 148 may be the same as the seed value when the background image prompt 142 is inputted into the diffusion model 146 to generate the background image 150. By using the same seed value, the game asset images 148 and the background image 150 can be generated with consistent noise patterns, which in turn contribute to stylistic coherence between the final rendered images 148, 150. This ensures that the game asset images 148 and the background image 150 can all share visual characteristics, such as stroke weight, color palette, lighting, and artistic rendering style, that are defined in the common style description 130.

The control network 132 comprises an encoder 132a which is a trainable copy of the encoder 146a of the diffusion model 146. The control network 132 also includes zero-initialized convolutional layers 132b that are placed at the output of the encoder 132a, and a middle block 132b which is a trainable copy of the middle block 146b of the diffusion model 146. The layout 140 is inputted into the encoder 132a of the control network 132. The background image prompt 142 with the common style description 130 may be inputted into the attention layers of the encoder 132a and/or the middle block 132c. The zero-initialized convolutional layers 132b, which are 1×1 convolutional layers with both weights and biases introduced to zeros, transform the features generated by the encoder 132a before injection into the diffusion model 146 as features 134 or control signals of the control network 132. The features 134 outputted by the control network 132 are inputted into the skip-connections and middle block 146b of the diffusion model 146. The skip-connections, which are direct links that connect the encoder layers of the encoder 146a to the corresponding decoder layers of the decoder 146c, preserve spatial information that may have been lost during the downsampling process in the encoder 146a.

The generated game asset images 148 and the background image 150 may be further edited by image processing modules. For example, a salient object segmentation algorithm may be applied to the game asset images 148 and the background image 150 to identify and isolate and separate the key objects and entities within the images 148, 150.

The final stage involves the game builder 152, which constructs the final game application 156 by using the generated game asset images 148 and the background image 150. The final output or response 154 includes not only the fully developed game application 156 but also a natural language response 158, which provides a descriptive summary or relevant guidance regarding the generated game application 156, offering the user a comprehensive overview of their creation.

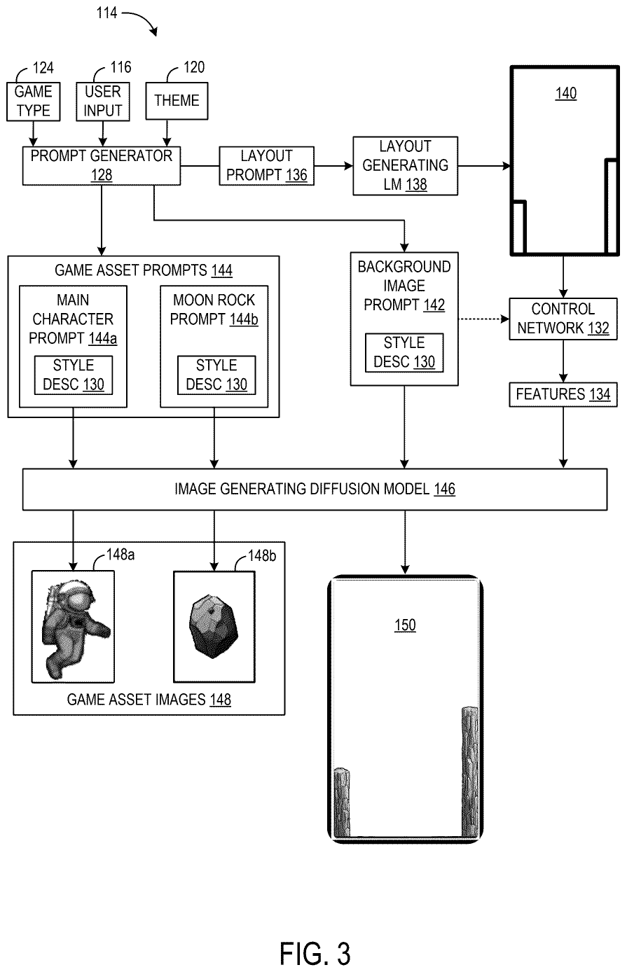

Referring to FIG. 3, an example is depicted of the process of using a control network 132 and an image generating diffusion model 146 to generate game asset images 148a, 148b and the background image 150 of a space platformer game. Based on the user input 116, the identified theme 120, and the identified game type 124, the prompt generator 128 generates game asset prompts 144, including a main character prompt 144a stating “Generate an image of an astronaut character for a sci-fi-style space platformer game. The astronaut should be depicted in a high-tech spacesuit with a futuristic design, featuring metallic textures, glowing neon blue accents, and intricate details. The helmet should be reflective with a translucent visor showing a hint of the character's face. The suit should include built-in utility packs, a jetpack, and gauntlets with illuminated controls.”

The game asset prompts 144 generated by the prompt generator 128 also includes a moon rock prompt 144b stating “Generate an image of a moon rock as a structural element for a sci-fi-style space platformer game. The moon rock should have a rugged and jagged appearance, with an irregular shape and rough, craggy surface textures. Incorporate metallic and crystalline deposits that glow with neon green and blue accents, giving the rock a futuristic, otherworldly feel.” The prompt generator 128 also generates a background image prompt 142 stating, “Generate a sci-fi style background image for a space game environment. The scene features a rocky lunar landscape with jagged moon rocks and tall, alien-looking stalagmites that serve as platforms for gameplay.”

The main character prompt 144a, the moon rock prompt 144b, and the background image prompt 142 also include a common style description 130 stating, “Utilize a futuristic color palette consisting of dark grays, metallic silvers, and glowing neon accents (such as blues, greens, or purples). Each element should have crisp, defined outlines with a medium stroke weight of approximately 2-3 pixels on a neutral background, incorporating subtle glows and high contrast shading to emphasize the sci-fi aesthetic, evoking an immersive, futuristic adventure.”

The prompt generator 128 also generates a layout prompt 136 stating, “Generate a layout for a platformer game with the following requirements: The layout must include a starting pillar at the leftmost part of the level and an end pillar at the rightmost part. The end pillar's height must be greater than that of the starting pillar.

Define the x, y coordinates for each pillar, ensuring that there is a navigable path of varying heights between the starting and end pillars. The pillars should be spaced at consistent or variable intervals along the x-axis, and their y-coordinates should create a challenging but feasible progression for gameplay. The layout should be output in a structured format, listing each pillar by its x, y coordinates and height. Example format: Starting Pillar: x=0, y=0, height=10, End Pillar: x=20, y=0, height=20.”

Responsive to receiving the layout prompt 136, the layout generating language model 138 generates a layout 140 which is an image with simple rectangles for the pillars in the background image. The layout 140 and the background image prompt 142 are inputted into the control network 132 to generate features 134 which are fed into the skip-connections and the middle block of the diffusion model 146 to guide the process of generating the game asset images 148, including the main character image 148a and the moon rock image 148b, and the background image 150.

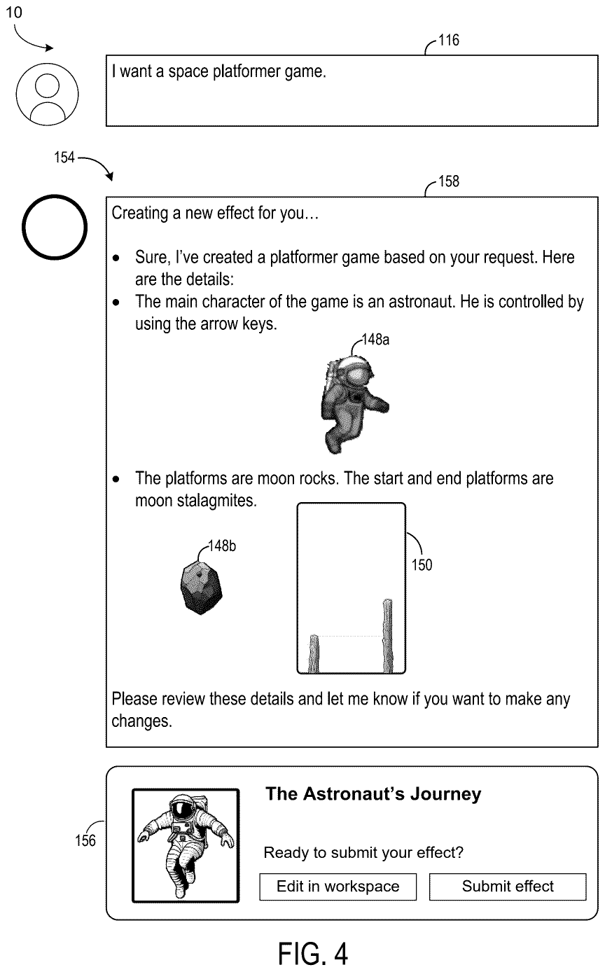

FIG. 4 illustrates an example scenario in which a user inputs a user input 116: “I want a space platformer game.” The game maker model 114 processes this user input 116 to generate a tailored game application 156.

Upon receiving the user input 116, the theme determination module 118 analyzes the request and determines that the appropriate theme is “space”, and the game type determination module 122 analyzes the request and identifies that the appropriate game type 120 is a platformer game. The prompt generator 128 then generates prompts in accordance with the example of FIG. 3 to generate the game asset images 148 and the background image 150.

The game builder 152 then assembles the game application 156 using the game asset images 148 and the background image 150 generated by the game element generator 126. The resulting game features are conveyed to the user through a response 154 including a natural language response 158 that outlines the key details of the generated game. The natural language response 158 specifies that the main character of the game is an astronaut 148a who is controlled by the user using the arrow keys. The platforms are moon rocks 148b, and the start and end platforms are moon stalagmites in the background image 150.

The response 154 also includes a link to the game application 156 with prompts asking the user whether the ‘effect’ (the generated game) is ready to be submitted or edited further in the workspace. In other words, the response 154 invites a subsequent user input to modify the game application 156.

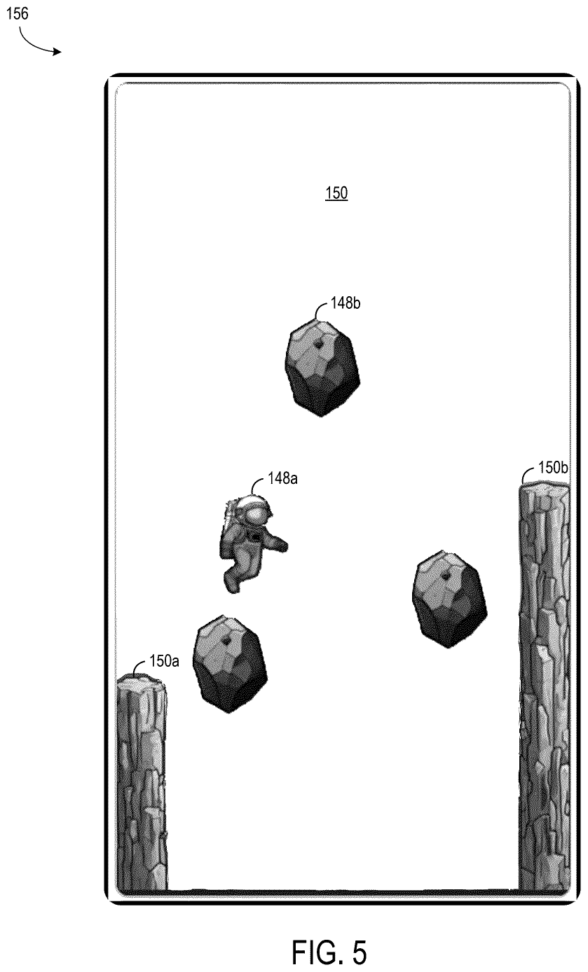

FIG. 5 illustrates an example of a screenshot of the game application 156 generated in the example of FIGS. 3 and 4, showcasing a distinctively styled space adventure scene. The visual elements within the game application 156, including the astronaut 148a, the moon rocks 148b, and the background image 150, maintain a consistent futuristic aesthetic that was prescribed by the common style description 130 of the game asset prompts 144 and the background image prompt 142 that were used by the image generating diffusion model 146 in the asset image generation process. This aesthetic consistency ensures an engaging and immersive user experience throughout gameplay.

The game environment depicted in FIG. 5 features a start platform 150a and an end platform 150b, each rendered as moon stalagmites that rise prominently from the surface of a stylized lunar terrain. The moon stalagmites 150a, 150b are crafted with a medium stroke weight of approximately 2-3 pixels in accordance with the common style description 130 of the background image prompt 142, and exhibit a futuristic color palette dominated by dark grays and metallic silvers, with glowing neon accents subtly integrated into their contours.

Between the start platform 150a and the end platform 150b, a series of floating moon rocks 148b is positioned to provide a traversable path for the astronaut character 148a. The moon rocks 148b are depicted using the same medium stroke weight and futuristic color palette as the background image 150, with surfaces that exhibit high contrast shading and subtle glows along their edges. The astronaut character 148a is illustrated leaping from one moon rock 148b to another. Like the moon rocks 148b and the background image 150, the astronaut 148a is also rendered with the same futuristic color palette and the same medium stroke weight of approximately 2-3 pixels in accordance with the common style description 130 of the main character prompt 144a.

Together, these game asset images 148a, 148b and the background image 150 create a visually coherent scene that illustrate how the background image prompt 142 and the game asset prompts 144 were leveraged to produce a harmonious, futuristic space adventure game application 156 with clear thematic and stylistic coherence.

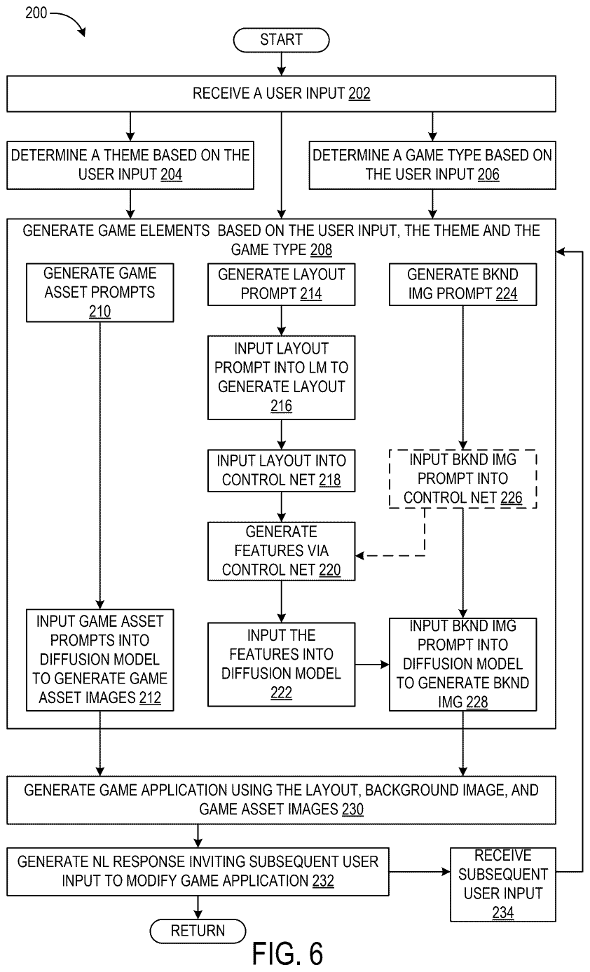

FIG. 6 shows a process flow diagram of an example method 200 for generating a game application. The example method 200 may be executed by the processing circuitry 102 and memory 104 of the computing system 10 of FIG. 1. The example method 200 includes, at step 202, receiving a user input, at step 204, determining a theme based on the user input, and at step 206, determining a game type based on the user input. At step 208, the method 200 includes generating game elements based on the user input, the theme, and the game type.

Step 208 includes step 210 of generating game asset prompts, and step 212 of inputting the game prompts into the diffusion model to generate game asset images. Step 208 also includes step 214 of generating a layout prompt, step 216 of inputting the layout prompt into a language model to generate a layout, step 218 of inputting the layout into a control network, step 220 of generating features via the control network, and step 222 of inputting the features into the diffusion model.

Step 208 also includes step 224 of generating a background image prompt. Step 208 may also include step 226 of inputting the background image prompt into the control network to generate features via the control network at step 220. At step 228, the background image prompt is inputted into the diffusion model to generate the background image.

The method 200 also includes step 230 of generating the game application using the layout, the background image, and the game asset images, step 232 of generating a natural language response inviting a subsequent user input to modify the game application. When, at step 234, a subsequent user input is received, the method 200 proceeds to step 204 of generating the game elements based on the user input, the theme, and the game type.

As described throughout herein, by leveraging a diffusion model with a prompt generator to streamline the game development process, high quality game creation can be democratized to be accessible for casual users. The above-described system and method bridge the gap between human creativity and machine-driven automation in game development, offering a scalable, adaptive approach that interprets user inputs, translate them into game asset images with stylistic and thematic consistency, and generate visually cohesive game applications with minimal manual intervention, thereby empowering a wider range of users to bring their creative visions to life.

In some embodiments, the methods and processes described herein may be tied to a computing system of one or more computing devices. In particular, such methods and processes may be implemented as a computer-application program or service, an application-programming interface (API), a library, and/or other computer-program product.

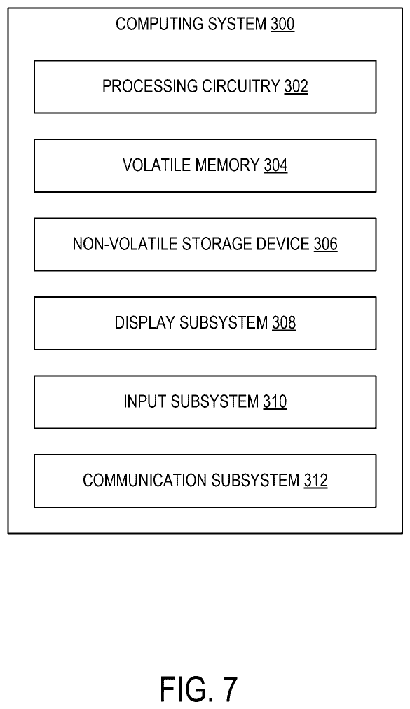

FIG. 7 schematically shows a non-limiting embodiment of a computing system 300 that can enact one or more of the methods and processes described above. Computing system 300 is shown in simplified form. Computing system 300 may embody the computing system 10 described above and illustrated in FIG. 1. Components of computing system 300 may be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 300 includes processing circuitry 302, volatile memory 304, and a non-volatile storage device 306. Computing system 300 may optionally include a display subsystem 308, input subsystem 310, communication subsystem 312, and/or other components not shown in FIG. 7.

Processing circuitry 302 typically includes one or more logic processors, which are physical devices configured to execute instructions. For example, the logic processors may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the processing circuitry 302 may be single-core or multi-core, and the instructions executed thereon may be configured for sequential, parallel, and/or distributed processing. Individual components of the processing circuitry 302 optionally may be distributed among two or more separate devices, which may be remotely located and/or configured for coordinated processing. For example, aspects of the computing system disclosed herein may be virtualized and executed by remotely accessible, networked computing devices configured in a cloud-computing configuration. In such a case, these virtualized aspects are run on different physical logic processors of various different machines, it will be understood. These different physical logic processors of the different machines will be understood to be collectively encompassed by processing circuitry 302.

Non-volatile storage device 306 includes one or more physical devices configured to hold instructions executable by the processing circuitry 302 to implement the methods and processes described herein. When such methods and processes are implemented, the state of non-volatile storage device 306 may be transformed—e.g., to hold different data.

Non-volatile storage device 306 may include physical devices that are removable and/or built in. Non-volatile storage device 306 may include optical memory, semiconductor memory, and/or magnetic memory, or other mass storage device technology. Non-volatile storage device 306 may include nonvolatile, dynamic, static, read/write, read-only, sequential-access, location-addressable, file-addressable, and/or content-addressable devices. It will be appreciated that non-volatile storage device 306 is configured to hold instructions even when power is cut to the non-volatile storage device 306.

Volatile memory 304 may include physical devices that include random access memory. Volatile memory 304 is typically utilized by processing circuitry 302 to temporarily store information during processing of software instructions. It will be appreciated that volatile memory 304 typically does not continue to store instructions when power is cut to the volatile memory 304.

Aspects of processing circuitry 302, volatile memory 304, and non-volatile storage device 306 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 300 typically implemented in software by a processor to perform a particular function using portions of volatile memory, which function involves transformative processing that specially configures the processor to perform the function. Thus, a module, program, or engine may be instantiated via processing circuitry 302 executing instructions held by non-volatile storage device 306, using portions of volatile memory 304. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 308 may be used to present a visual representation of data held by non-volatile storage device 306. The visual representation may take the form of a graphical user interface (GUI). As the herein described methods and processes change the data held by the non-volatile storage device, and thus transform the state of the non-volatile storage device, the state of display subsystem 308 may likewise be transformed to visually represent changes in the underlying data. Display subsystem 308 may include one or more display devices utilizing virtually any type of technology. Such display devices may be combined with processing circuitry 302, volatile memory 304, and/or non-volatile storage device 306 in a shared enclosure, or such display devices may be peripheral display devices.

When included, input subsystem 310 may comprise or interface with one or more user-input devices such as a keyboard, mouse, touch screen, camera, or microphone.

When included, communication subsystem 312 may be configured to communicatively couple various computing devices described herein with each other, and with other devices. Communication subsystem 312 may include wired and/or wireless communication devices compatible with one or more different communication protocols. As non-limiting examples, the communication subsystem may be configured for communication via a wired or wireless local- or wide-area network, broadband cellular network, etc. In some embodiments, the communication subsystem may allow computing system 300 to send and/or receive messages to and/or from other devices via a network such as the Internet.

The following paragraphs provide additional description of the subject matter of the present disclosure. One aspect provides a computing system for generating a game application, the computing system comprising processing circuitry and memory storing a game maker model that, when executed, cause the processing circuitry to receive a user input, generate a plurality of game asset prompts and a background image prompt based on the user input, the plurality of game asset prompts and the background image prompt including a common style description, input the plurality of game asset prompts and the background image prompt into a diffusion model to generate a plurality of game asset images and a background image, respectively, and generate the game application using the plurality of game asset images and the background image. In this aspect, additionally or alternatively, a layout prompt may be generated based on the user input, and the layout prompt may be inputted into a language model to generate a layout. In this aspect, additionally or alternatively, the layout may be inputted into a control network to generate features, and the features may be inputted into the diffusion model to generate the background image. In this aspect, additionally or alternatively, the background image prompt and the layout may be inputted into the control network to generate the features. In this aspect, additionally or alternatively, the control network may comprise an encoder configured to be a trainable copy of an encoder of the diffusion model, zero-initialized convolutional layers placed at an output of the encoder of the control network, and a middle block configured to be a trainable copy of a middle block of the diffusion model, and the layout is inputted into the encoder of the control network. In this aspect, additionally or alternatively, the layout may be an image representation defining coordinates for each structural element in the game application. In this aspect, additionally or alternatively, a seed value of the diffusion model when the game asset prompt is inputted into the diffusion model may be the same as a seed value of the diffusion model when the background image prompt is inputted into the diffusion model. In this aspect, additionally or alternatively, the common style description may define at least a stroke weight, a color palette, lighting, or artistic rendering style for the plurality of game asset images and the background image. In this aspect, additionally or alternatively, the plurality of game asset images may include images of main entities, secondary entities, and environmental assets. In this aspect, additionally or alternatively, the processing circuitry may be configured to further generate a natural language response inviting a subsequent user input to modify the game application.

Another aspect provides a computing method for generating a game application, the computing method comprising receiving a user input, generating a plurality of game asset prompts and a background image prompt based on the user input, the plurality of game asset prompts and the background image prompt including a common style description, inputting the plurality of game asset prompts and the background image prompt into a diffusion model to generate a plurality of game asset images and a background image, respectively, and generating the game application using the plurality of game asset images and the background image. In this aspect, additionally or alternatively, a layout prompt may be generated based on the user input, and the layout prompt may be inputted into a language model to generate a layout. In this aspect, additionally or alternatively, the layout may be inputted into a control network to generate features, and the features may be inputted into the diffusion model to generate the background image. In this aspect, additionally or alternatively, the background image prompt and the layout may be inputted into the control network to generate the features. In this aspect, additionally or alternatively, the layout may be inputted into an encoder of the control network. In this aspect, additionally or alternatively, the layout may be an image representation defining coordinates for each structural element in the game application. In this aspect, additionally or alternatively, a seed value of the diffusion model when the game asset prompt is inputted into the diffusion model may be set the same as a seed value of the diffusion model when the background image prompt is inputted into the diffusion model. In this aspect, additionally or alternatively, the common style description may define at least a stroke weight, a color palette, lighting, or artistic rendering style for the plurality of game asset images and the background image. In this aspect, additionally or alternatively, the computing method may further comprise generating a natural language response inviting a subsequent user input to modify the game application.

Another aspect provides a computing system for generating a game application, the computing system comprising processing circuitry and memory storing instructions that, when executed, cause the processing circuitry to receive a user input, determine a plurality of game asset prompts and a background image prompt based on the user input, input the plurality of game asset prompts and the background image prompt into a diffusion model to generate a plurality of game asset images and a background image, respectively, and generate the game application using the plurality of game asset images and the background image, a seed value of the diffusion model when the game asset prompt is inputted into the diffusion model being set the same as a seed value of the diffusion model when the background image prompt is inputted into the diffusion model.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

It will be appreciated that “and/or” as used herein refers to the logical disjunction operation, and thus A and/or B has the following truth table.

| A | B | A and/or B |
|---|---|---|
| T | T | T |
| T | F | T |
| F | T | T |
| F | F | F |

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system for generating a game application, the computing system comprising:
processing circuitry and memory storing a game maker model that, when executed, cause the processing circuitry to:
receive a user input;
generate a plurality of game asset prompts and a background image prompt based on the user input, the plurality of game asset prompts and the background image prompt including a common style description;
input the plurality of game asset prompts and the background image prompt into a diffusion model to generate a plurality of game asset images and a background image, respectively; and
generate the game application using the plurality of game asset images and the background image.

2. The computing system of claim 1, wherein
a layout prompt is generated based on the user input; and
the layout prompt is inputted into a language model to generate a layout.

3. The computing system of claim 2, wherein
the layout is inputted into a control network to generate features; and
the features are inputted into the diffusion model to generate the background image.

4. The computing system of claim 3, wherein the background image prompt and the layout are inputted into the control network to generate the features.

5. The computing system of claim 4, wherein
the control network comprises:
an encoder configured to be a trainable copy of an encoder of the diffusion model,
zero-initialized convolutional layers placed at an output of the encoder of the control network, and
a middle block configured to be a trainable copy of a middle block of the diffusion model; and
the layout is inputted into the encoder of the control network.

6. The computing system of claim 2, wherein the layout is an image representation defining coordinates for each structural element in the game application.

7. The computing system of claim 1, wherein a seed value of the diffusion model when the game asset prompt is inputted into the diffusion model is the same as a seed value of the diffusion model when the background image prompt is inputted into the diffusion model.

8. The computing system of claim 1, wherein the common style description defines at least a stroke weight, a color palette, lighting, or artistic rendering style for the plurality of game asset images and the background image.

9. The computing system of claim 1, wherein the plurality of game asset images include images of main entities, secondary entities, and environmental assets.

10. The computing system of claim 1, wherein the processing circuitry is configured to further generate a natural language response inviting a subsequent user input to modify the game application.

11. A computing method for generating a game application, the computing method comprising:
receiving a user input;
generating a plurality of game asset prompts and a background image prompt based on the user input, the plurality of game asset prompts and the background image prompt including a common style description;
inputting the plurality of game asset prompts and the background image prompt into a diffusion model to generate a plurality of game asset images and a background image, respectively; and
generating the game application using the plurality of game asset images and the background image.

12. The computing method of claim 11, wherein
a layout prompt is generated based on the user input; and
the layout prompt is inputted into a language model to generate a layout.

13. The computing method of claim 12, wherein
the layout is inputted into a control network to generate features; and
the features are inputted into the diffusion model to generate the background image.

14. The computing method of claim 13, wherein the background image prompt and the layout are inputted into the control network to generate the features.

15. The computing method of claim 14, wherein the layout is inputted into an encoder of the control network.

16. The computing method of claim 12, wherein the layout is an image representation defining coordinates for each structural element in the game application.

17. The computing method of claim 11, wherein a seed value of the diffusion model when the game asset prompt is inputted into the diffusion model is set the same as a seed value of the diffusion model when the background image prompt is inputted into the diffusion model.

18. The computing method of claim 11, wherein the common style description defines at least a stroke weight, a color palette, lighting, or artistic rendering style for the plurality of game asset images and the background image.

19. The computing method of claim 11, further comprising generating a natural language response inviting a subsequent user input to modify the game application.

20. A computing system for generating a game application, the computing system comprising:
processing circuitry and memory storing instructions that, when executed, cause the processing circuitry to:
receive a user input;
determine a plurality of game asset prompts and a background image prompt based on the user input;
input the plurality of game asset prompts and the background image prompt into a diffusion model to generate a plurality of game asset images and a background image, respectively; and
generate the game application using the plurality of game asset images and the background image, wherein
a seed value of the diffusion model when the game asset prompt is inputted into the diffusion model is set the same as a seed value of the diffusion model when the background image prompt is inputted into the diffusion model.
